(19) United States
(12) Patent Application Publication
(10) Pub. No.: US 2026/0361613 A1
(43) Pub. Date: Nov. 12, 2026

(54) ML MODEL TRANSFER AND UPDATE BETWEEN UE AND NETWORK

(71) Applicant: Nokia Technologies Oy, Espoo (FI)

(72) Inventors: Amaanat ALI, Espoo (FI); Sakira HASSAN, Espoo (FI); Afef FEKI, Massy (FR); István Zsolt KOVÁCS, Aalborg (DK); Ahmad MASRI, Tampere (FI); Fahad SYED MUHAMMAD, Massy (FR); Sina KHATIBI, Munich (DE); Jian SONG, Massy (FR)

(21) Appl. No.: 19/132,015

(22) PCT Filed: Nov. 1, 2023
(86) PCT No.: PCT/EP2023/080460

§ 371 Date: May 22, 2025

(30) Foreign Application Priority Data
Nov. 23, 2022 (FI) 20226045

(51) Int. Cl. H04L 41/16; G06N 20/00

(52) U.S. Cl. CPC H04L 41/16; G06N 20/00

(57) ABSTRACT

In some embodiments, there may be provided receiving a request for a machine learning model, wherein the request comprises information on at least one model adaptation constraint for training of the machine learning model or an inference of the machine learning model; and in response to the access node being able to adapt the machine learning model, adapting the machine learning model using the at least one model adaptation constraint, determining at least one instruction for monitoring performance of the machine learning model and/or for monitoring at least one user equipment performance indicator, transmitting the machine learning model and the at least one instruction, and receiving information on monitoring carried out based on the at least one instruction, or failure information indicating the user equipment failure to apply the machine learning model. Related systems, methods, and articles of manufacture are also disclosed.

### FIELD

The subject matter described herein relates to machine learning and wireless communications.

### BACKGROUND

Federated learning refers to a machine learning (ML) technique. In federated learning, a central server may pool the learning occurring across machine learning models at client nodes, without the central server having access to the local training data at the client nodes so the privacy of the local data is maintained. In the case of federated learning, ML models may be transferred frequently between the central server and the client nodes.

### SUMMARY

In some example embodiments, there may be provided a method that includes transmitting, by a user equipment and to an access node, a request for a machine learning model, wherein the request comprises information on at least one model adaptation constraint for training of the machine learning model or an inference of the machine learning model; receiving, by the user equipment and from the access node, the machine learning model that is adapted in accordance with the at least one model adaptation constraint, and at least one instruction for monitoring performance of the machine learning model and/or for monitoring at least one user equipment performance indicator; applying, by the user equipment, the machine learning model to the training of the machine learning model or the inference of the machine learning model; monitoring, by the user equipment, the machine learning model and/or the at least one user equipment performance indicator according to the at least one instruction; and transmitting, by the user equipment and to the access node, information on at least one of the performance or failure information indicating the user equipment failure to apply the machine learning model.

In some variations, one or more of the features disclosed herein including the following features can optionally be included in any feasible combination. The user equipment may receive from the access node the machine learning model that is not adapted in accordance with the at least one model adaptation constraint, and the at least one instruction for monitoring performance of the machine learning model and/or for monitoring the at least one user equipment performance indicator. The user equipment may adapt the machine learning model before continuing with the applying, the monitoring, and the transmitting information on at least one of the performance or the failure information indicating the user equipment failure to at least one of apply or adapt the machine learning model. In response to the monitoring of the performance indicating there is no failure to apply or adapt the machine learning model at the user equipment, the user equipment may continue to use the machine learning model. In response to the monitoring performance indicating a failure to apply or adapt the machine learning model at the user equipment, the user equipment may switch to at least one of a non-machine learning mode for performing a task of the machine learning model and a prior version of the machine learning mode for performing the task. The machine learning model may be adapted in accordance with the at least one model adaptation constraint by at least compressing the machine learning model by at least one of a weight pruning, a structural pruning, a weight quantization, or a machine learning model architecture change. The at least one model adaptation constraint may include at least one of a constraint related to the machine learning model, a constraint related to a user equipment resource constraint, a battery life of the user equipment, or a latency requirement for the inference of the machine learning model. The at least one instruction for monitoring performance of the machine learning model comprises one or more metrics for evaluating the performance of the machine learning model, and/or wherein the at least one user equipment performance indicator comprises one or more key performance indicators.

In some example embodiments, there may be provided a method that includes receiving, by an access node and from a user equipment, a request for a machine learning model, wherein the request comprises information on at least one model adaptation constraint for training of the machine learning model or an inference of the machine learning model; and in response to the access node being able to adapt the machine learning model, adapting, by the access node, the machine learning model using the at least one model adaptation constraint, determining, by the access node, at least one instruction for monitoring performance of the machine learning model and/or for monitoring at least one user equipment performance indicator, transmitting, by the access node and to the user equipment, the machine learning model and the at least one instruction, and receiving, by the access node from the user equipment, information on monitoring carried out based on the at least one instruction, or failure information indicating the user equipment failure to apply the machine learning model.

In some variations, one or more of the features disclosed herein including the following features can optionally be included in any feasible combination. The access node may transmit the machine learning model in an un-adapted form to the user equipment, in response to the access node not being able to adapt the machine learning model using the at least one model adaptation constraint. In response to receiving the information on monitoring carried out based on the at least one instruction, or the failure information indicating the user equipment failure to apply the machine learning model, the method may comprise further adapting, by the access node, the machine learning model using the information from the user equipment. The machine learning model that is adapted in accordance with the at least one model adaptation constraint may be adapted by at least compressing the machine learning model using at least one of a weight pruning, a structural pruning, a weight quantization, or a machine learning model architecture change. The at least one instruction for monitoring performance of the machine learning model may comprise one or more metrics for evaluating the performance of the machine learning model, and/or wherein the at least one user equipment performance indicator comprises one or more key performance indicators. The access node may comprise or be comprised in at least one of a radio access network node, a gNB type base station, a server.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 shows an example of federated learning process among a plurality of user equipment, in accordance with some embodiments;

FIGS. 2A, 2B, and 2C depict examples of processes for transferring a machine learning model, in accordance with some example embodiments;

FIG. 3A depicts an example of various constraints, in accordance with some embodiments;

FIG. 3B depicts an example process at a user equipment for ML model adaption, in accordance with some embodiments;

FIG. 3C depicts an example process at an access node for ML model adaption, in accordance with some embodiments;

FIG. 4 depict an example of a ML model, in accordance with some example embodiments;

FIG. 5 depicts an example of a network node, in accordance with some example embodiments; and

FIG. 6 depicts an example of an apparatus, in accordance with some example embodiments.

Like labels are used to refer to same or similar items in the drawings.

### DETAILED DESCRIPTION

As machine learning (ML) becomes more prevalent, the cellular system, such as 5G and beyond, will be increasingly reliant on the use of ML. For example, an ML model may be trained such that during an inference phase the ML model may be used in 5G to perform a task, such as using the ML model for channel state information (CSI) compression, prediction of “best” beams for beam selection in time and spatial domain, mobility handling of the UE, link level performance, and for other applications or functions in the cellular system. As such, the ML model may need to be transferred over an air interface between a network node, such as a base station (e.g., next generation evolved Node B, gNB) and a user equipment (UE). Moreover, the ML model may be transferred over the air interface to provide an update to an ML model. However, UEs may vary in their constraints to handle the processing associated with a given ML model.

In some embodiments, there may be provided signaling between a UE and a network node (e.g., gNB), such that the network node can assess the constraints (also referred to herein as model adaption constraints) at the UE for handling a given ML model. For example, one or more constraints (e.g., one or more UE capabilities related to ML) may enable the network node to adapt an ML model for a given UE (or group of UEs having the same or similar constraints for handling ML models). In some embodiments, the adaptation may include compressing the ML model by for example pruning the ML model and/or adapting the quantization used for the parameters of the ML model.

Before providing additional details about the signaling between at least one UE and a network node such as a gNB, the following describes an example of a ML learning use case where an ML model is transferred between the network node and a UE.

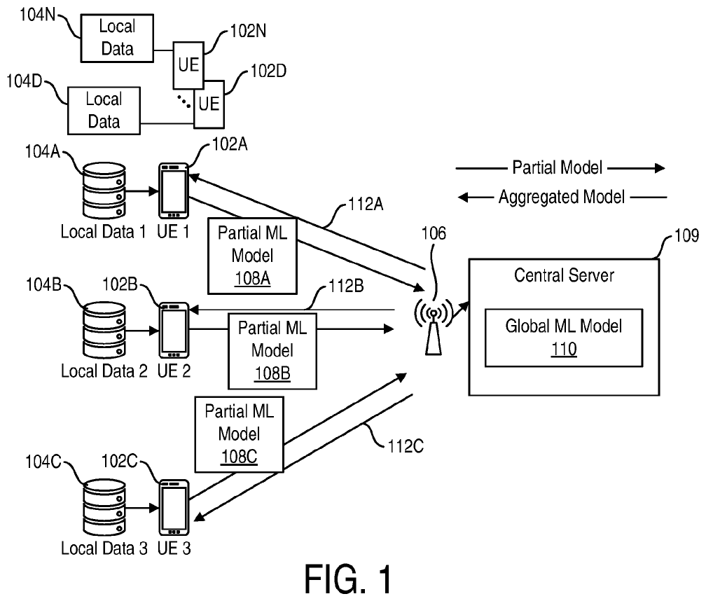

FIG. 1 shows an example of a federated learning process among a plurality of user equipment, in accordance with some embodiments. Although the following example describes federated learning, this is merely an example as the ML models transferred over the air interface may use other types of learning, such as unsupervised learning, supervised learning, reinforcement learning, semi-supervised learning, self-supervised learning, and/or the like.

In the case of federated learning, ML models may be transferred over the UE-gNB air interface at least one time as demonstrated in the example below.

In the example of FIG. 1, there may be a plurality of UEs 102A-N. In federated learning, the gNB 106 may provide to, for example, UEs 102A-C an initial ML model. Each of the UEs 102A-C use their own local data 104A-C to train the initial ML model. For example, the UE 102A may train the initial ML model using its local data 104A without accessing the local data 104B-C; UE 102B may train the initial ML model using its local data 104B; UE 102C trains the initial ML model using its local data 104C. In this way, training can take place but each of the UEs do not share private local data with other UEs or the network. Next, the UEs 104A-C each sends a partial ML model 108A-C towards the gNB 106. The sending of the partial ML model may comprise sending the parameters (e.g., weights, activations, and/or other configuration information) for the partial ML model (but the local data 104A-C is not sent as noted).

The gNB 106 (or a central server 109 coupled to the gNB 106) may then combine (e.g., aggregate the partial ML models 108A-C) to form a “global” ML model 110 (also referred to as an “aggregate” ML model). The global ML model may be transferred at 112A-C to at least the UEs 102A-C. The UEs 102A-C may perform additional training of the global ML model 108 and return it to the gNB and/or central server 109. For example, a predetermined quantity of training iterations (or a predetermined error threshold) may be used to determine whether additional training of the global ML model is needed at each of the UEs 102A-C using their corresponding local data 104A-C.

To illustrate further, with a training iterations of 1 for example, the global (or aggregate) ML model 110 provided at 112A-C may be used for an inference phase to perform a task. If the training iterations is 2 for example, the global (or aggregate) ML model 110 provided at 112A-C may be trained again using local data by each of the UEs 102A-C and returned to the gNB for aggregation, forming thus a second version of the global ML model. This second version of the global (or aggregate) ML model 110 provided at 112A-C to the UEs may be used for an inference phase to perform a task. Although this example refers to training iterations, a predetermined error threshold (e.g., perform additional training until an error of the task performed by the global ML model is below a threshold error) may be used as well.

Alternatively, or additionally, the UEs 102A-C may use the global ML model 110 provided at 112A-C for an inference phase, during which the global ML model is used to perform a task, such as a ML task (e.g., the CSI compression, beam selection, or other task). Alternatively, or additionally, the global ML model 110 may be provided to additional UEs 102D-N with the global ML model 110 for use during an inference phase to enable those additional UEs to perform the task.

The central server 109 may be comprised as an edge server located at the radio access network associated with the gNB 106. Alternatively, or additionally, the central server 109 may be comprised in the core network, such as the 5G core network. Alternatively, or additionally, the central server 109 may be comprised as a cloud service.

In federated learning, the process may include an initialization phase during which an ML model is selected to be trained at the local nodes, such as UEs 102A-C. For example, the ML model may be selected for CSI compression, while another ML model may be selected to perform another task such as beam selection and/or the like. The process may also include a training client selection phase, during which one or more of the local nodes are selected to perform the federated learning of the ML model. For example, the central server 109 may select a subset of the UEs 102A-N for federated learning, so in the example of FIG. 1 the selected nodes are UE 102A-C. Each of the selected UEs 102A-C may perform the local training of the initial (or global) ML model using a corresponding set of local data 104A-C. In a reporting phase, the selected UEs 102A-C may each send their locally trained ML model 108A-C to the gNB 106 (and/or central server 109), where ML model aggregation is performed. During training, a pre-defined termination criterion may be satisfied (e.g., a predefined criterion, such as a maximum number of iterations during training, performance threshold, error threshold, and/or the like). When the pre-defined termination criterion has not been reached, the central server 109 may send the global ML model 110 to the UEs for additional training using local data, and these UE respond with partial ML models. When the pre-defined termination criterion is reached, the central server 109 may publish the global ML model 110 to at least the UEs 102A-C as well as other UEs to enable the UEs to use the global ML model for inference (e.g., to perform one or more tasks such as the CSI compression, beam selection, and/or the like).

Although the previous example refers to federated learning (FL), ML model transfer over the air interface between the UEs 102A-C and base station 106 may, as noted, be realized with other types of ML models as well as other types of ML training schemes.

The ML model transfer to the UE may involve partial training at the UE (e.g., where the UEs perform a part of the training as in the case of federated learning) or full training at the network side, such as at the gNB 106 (or server 109). The trained ML model may be transferred over the air interface to the UEs 102A-C to perform ML related tasks using the trained ML model. This transfer of the ML model raises some issues. For example, a first issue relates to how an ML model may be adapted to a given UE's constraints, such as availability of CPU resources, availability of a specialized machine learning processor such as an AI chip, availability of memory, availability of a hardware accelerator, current state of the battery, current mode of the UE (e.g., power save mode), UE mobility state changes, and/or other model adaptation constraints at the UE. To illustrate further, a given ML model may, in some instances, be adapted to operate in a UE having limited capabilities (when compared to another UE), while still providing a viable or useful ML model. Although in some other instances, the adapted ML model may not be viable and, as such, not provide reliable inferences. As such, the network (and/or UE) may need to be aware of a UE's constraints (e.g., capabilities) when deciding what (or even if) to transfer a ML model and/or an “adapted” ML model. Another issue with respect to the ML model use at the UE relates to how often, how much, and/or to what extent the ML model should be updated via additional training. One or more of these issues may be addressed via signaling between a UE and a network node, such as a gNB type base station or other node.

An ML model may be transferred, as noted, via the air interface between a network node (e.g., a radio access network node, a gNB, etc.) and one or more UEs. The ML model may be trained in a variety of ways (e.g., using federated learning, supervised learning, unsupervised learning, and/or the like). During an inference phase of the ML model for example, the ML model's output may provide an inference as in the case of the “best” beam selection noted above or perform some other task, such as the CSI compression, classification, and/or the like. However, a given UE (or group of UEs) may not have the capabilities, as noted, to handle a given ML model, which may operate in a power hungry manner, so the inference of the ML model may need additional processing resources for ML model execution at the UE, when compared to a UE that does not execute an ML model. For example, the ML model's inference phase may use too much of a UE's available resources and/or take too much time for a specific inference.

In some embodiments there may be provided a signaling mechanism, such as a messaging exchange, between radio access network (e.g., a gNB or other type of base station or access point) and the UE, such that the signaling supports ML model transfer (and/or ML model update) while taking into account ML model adaptation constraints of the UE.

In some embodiments, there is provided gNB UE signaling that defines the ML model adaptation constraints at a UE (or group of UEs) with selected constraints affecting the ML model training and/or inference. The UE's model adaptation constraints (or constraints, for short) with respect to machine learning may be processed at for example the gNB in order to decide whether to adapt the ML model before providing the ML model to the UE. And, if adaptation of the ML model to satisfy the constraints of the UE, the signaling may indicate the scope (e.g., how much) of the adaptation of the ML model before providing the “adapted” ML model to the UE. In some embodiments, the UE's constraints with respect to machine learning are indicated using categories, such as ML categories indicative of the constraints at the UE for handling an ML model. Although some of the examples refer to the network and the network node as a base station, such as a gNB, other types of network nodes, functions, and/or elements may be used as well.

In some embodiments, there may be provided a new function at gNB, such that the new function adapts (e.g., prepares, modifies, updates, and/or the like) the ML model in response to the UE's model adaption constraints (which may, for example, be in the form of the UE's ML category) signaled to the gNB by the UE. For example, the UE may indicate its constraints with respect to executing an ML model at the UE during an initial ML model deployment to the UE as well as at other times, such as when conditions at the UE change due to for example changes in battery level, available memory, available processor resources, UE mobility state changes, and/or the like.

In some embodiments, the network, such as the gNB or other network node, may cluster one or more UEs using the constraints of the UEs, and may prepare an ML model (or an update to an ML model) in response to these constraints. For example, a group of UEs may be clustered by the network, such that the UEs in the cluster have the same or similar ML constraints (e.g., as signaled to the network in a UE capability exchange with the network during an initial network attachment or at other times such as UE service request, etc.). In this example, the network may adapt an ML model based on the ML constraints and transfer the “adapted” ML model to the entire cluster of UEs. As noted, the transfer may include sending the parameters of the adapted ML model.

In some embodiments, the network, such as the gNB or other network node, may send the adapted (also referred to as prepared) ML model to one or more UEs, and this ML model may be a partial ML model (in which case the partial ML model may be further trained or tuned by the UE as noted in the federated learning example above) and/or a “complete” ML model ready for use to perform inferences at the UE (so the “complete” ML model does not require additional training or tuning by the UE).

In some embodiments, the network, such as the gNB or other network node, may indicate, via for example assistance information, to the UE the selected option with respect to whether a partial or complete ML model is provided to the UE. For example, the network may transfer a partial ML model to the UE. When this is the case, the UE may tune, adjust, and/or complete the partial ML model based on the UE's constraints. Alternatively, or additionally, the network may provide a complete ML model (e.g., complete in the sense that the UE does not need to tune or adjust the ML model) tailored to the UE's constraints. In either the case of the partial ML model or the complete ML model being transmitted to the UE, the network may indicate which of these two options is the selected option to inform the UE.

In some instances, the network such as the gNB or other network node, may not be able to adapt an ML model that meets the model adaptation constraints of a UE. For example, the UE's constraints may be so limited that the network may not be able to limit the scope of the ML model while providing a viable ML model which can be used by the UE to accurately perform the corresponding inference task of the ML model. When the network cannot adapt an ML model in response to a UE's constraints, the network may send to the UE(s) an indication that the ML model cannot be provided to the UE. Alternatively, or additionally, when the network cannot adapt an ML model in response to a UE's constraints, the network may send to the UE(s) the original trained ML model (e.g., which has not be prepared or adapted to accommodate UE ML constraints) with additional information that assists the UE with adaptation (e.g., for example different compression/pruning options, such as bit width restriction 16 or 32 bit, pruning options such as a suggestion to drop a given number of layers) while ML model accuracy can still be maintained after the adaptation. In this example, the UE may adapt the ML model to its own constraints and inform the gNB of the adaptations (and/or of the performance of the UE or ML model or a failure to apply or adapt the ML model).

The ML model exchanged between a UE and a network node such as the gNB may, as noted, be provide by sending ML model parameters (e.g., weights of a neural network and/or the like). And, the provided ML model parameters may also be sent with additional metadata, such as other configuration information for the ML model or ML model operation (e.g., operations related to training, data collection, pre-processing of data, and/or post-processing of data).

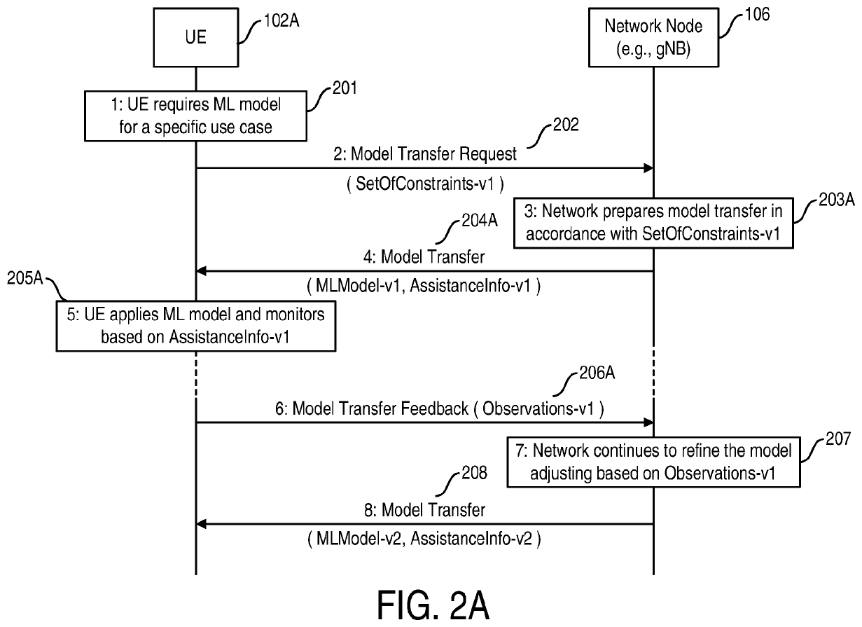

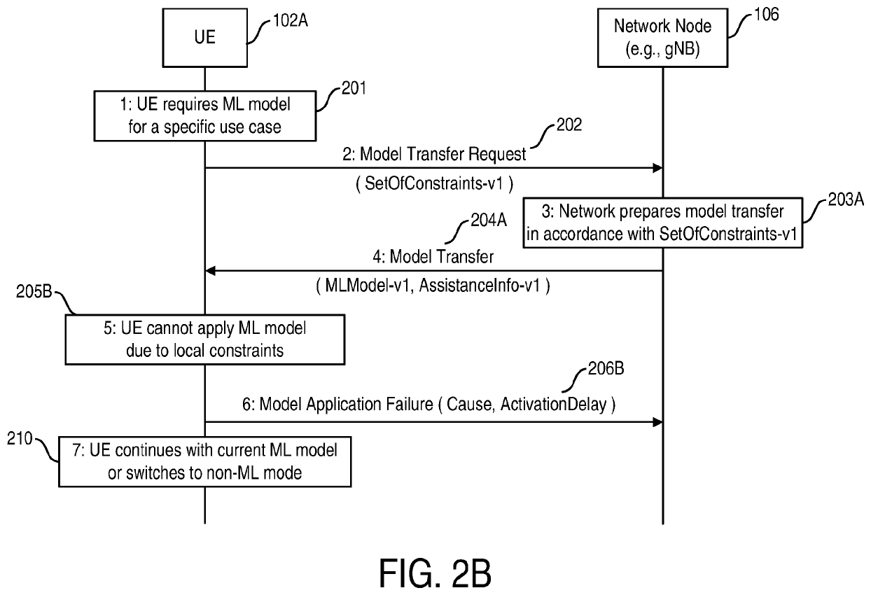

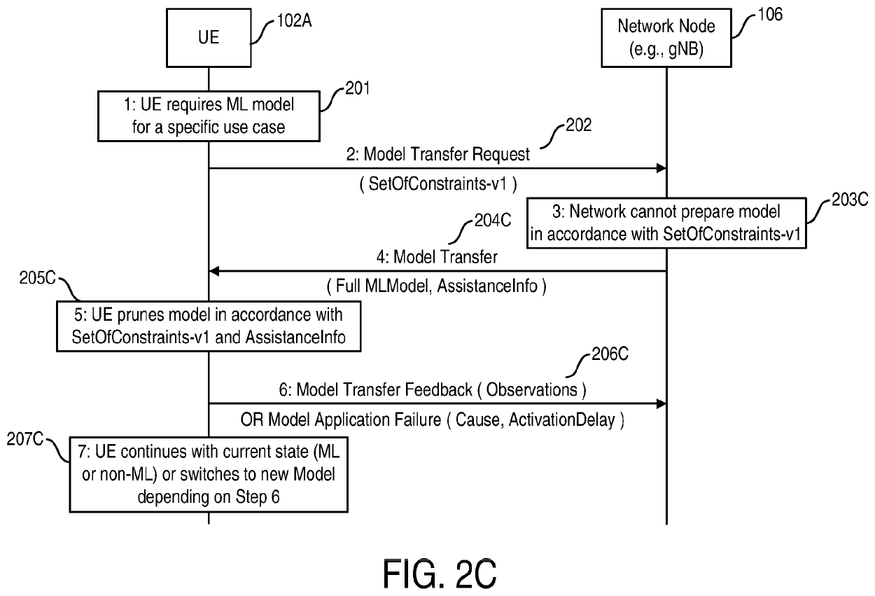

FIG. 2A depicts an example of a signaling process, in accordance with some embodiments. FIG. 2A depict the UE 102A and a network node, such as gNB 106. In the example of FIG. 2A, the ML model is prepared and transferred (e.g., transmitted, sent, granted access, etc.) by the gNB based on a request from the UE. Moreover, the ML model may be prepared based on the UE's constraints (e.g., UE's capabilities with respect to ML).

At 201, the UE 102A may have a requirement for an ML model, in accordance with some embodiments. And, the requirement may be for a specific task, such as an ML model trained to perform CSI compression, optimum beam selection, or other task.

When there is a requirement at 201 (or at other times as well), the UE 102A may send towards the network (e.g., a base station, such as gNB 106 or other type of base station, access point, or network node) a request 202. The request 202 may indicate to the network that an ML model is requested for transfer to the UE. For example, the UE may initiate the request 202 indicating a specific task or a specific ML model (e.g., an identifier that identifies a specific type of ML model, such as a ML model for a specific ML task, such as CSI compression or other task). The ML model requested at 202 may be a “partial” ML model that may need additional training by the UE or a so-called “complete” ML model that may not need additional training by the UE. For example, the identifier may map to (or otherwise identify) an ML model and/or a task (which is mapped to an ML model).

To illustrate further, a first indicator may map to an ML model trained for a CSI compression task, while a second indicator may map to an ML trained for a beam selection task. In some embodiments, the identifier and/or mapping to an ML model may be pre-defined (e.g., in a 3GPP standard or other type of standard). To illustrate the identifier may be a 128-bit identifier (although the identifier may take other lengths as well). In this example, the most significant 32 bits of the 128 bits may indicate a vendor ID (or a location of the ML model), the next 32 bits may include a scenario (e.g., application, task/use case, such as CSI compression, and/or the like), and the next 64 bits may serve as a data set ID that identifies the data used (or to be used) to train the ML model.

Alternatively, or additionally, the ML model transfer request 202 may include one or more UE model adaptation constraints (labeled “SetOfConstraints”) related to the UE's execution of the ML model. And, the model adaptation constraints (or “constraints,” for short) may be associated with version information, such as a counter, time stamp, or the like, to indicate to the UE and the network different versions of the constraints as at least some of the constraints may vary over time. The one or more UE model adaptation constraints may corresponds to one or more of the following constraints at the UE: a physical restriction at the UE with respect to hardware resources and/or software processing of the ML model; a maximum ML model size (e.g., ML model size in kilobytes, megabytes, and/or the like); a processing constraint dictated by a UE's specific capabilities, such as available memory at a UE; a maximum allowed processing power available at the UE for ML modeling (e.g., in floating point operations (FLOPS), teraFLOPS (TFLOPS), and/or the like); a bit width limitation for the ML model parameters (e.g., weights and bias that define or configure the ML model) in terms of for example 16 bits, 32 bits, 64 bits, or the like; an availability of a hardware accelerator or a generic processor capabilities at the UE (e.g., the presence or absence of a GPU, AI chip, a single core processor, a multi-core processor, a physical number of cores); battery power level at the UE, mobility state of the UE, mode of the UE (e.g., battery savings state of the UE), and/or other model adaptation constraints at the UE related to ML model training or inference the UE.

Moreover, the model adaptation constraints at the UE may be structured into a two-dimensional table, such as Table 1 below. In the example of Table 1, the UE model adaptation constraints are categorized, such as set 1, set 2, and so forth with a corresponding set of constraints. Referring to Set 1, the maximum model size is 16, with a quantization of 16, GPU cores available for the ML model of 4, and memory available for the ML model of 4 megabytes (MB), for example. As such, the selection of Set 1 defines the listed constraints, but if Set 2 is indicated, the constraints of a maximum model size is 32, with a quantization of 86, GPU cores available for the ML model of 2, and memory available for the ML model of 8 megabytes (MB), for example. Moreover, a given use case may be mapped to one or more of the sets. For example, if an ML model is for a CSI compression task, then Set 1 may be specified, but if an ML model is for beam selection, Set 2 may be selected.

TABLE 1

| Set of | Maximum | Quantization | GPU | Memory |
|---|---|---|---|---|
| constraints | model size MB | (Bits) | cores | (MB) |
| Set 1 | 16 | 16 | 4 | 4 |
| Set 2 | 32 | 8 | 2 | 8 |
| Set x | . . . | . . . | . . . | . . . |
| Set N-1 | 8 | 32 | 4 | 16 |
| Set N | UE prefers | UE prefers | N/A | N/A |
| | to adapt | to adapt | | |

In some embodiments, the model adaptation constraints may be dynamic (and as such may vary over time), in which case the UE may signal via request 202 an indication of the updated set of UE constraints for the ML model execution at the UE. For example, if the state of the UE changes due to for example processing resources change (or other change such as the UE battery power level going below a threshold amount, or the UE switching its operation from a single connection to dual connectivity), the constraints at the UE change, so this change may trigger the UE to send a request 202 with updated UE model adaptation constraints to show for example the decrease in available resources for the ML model. Moreover, the dynamic signaling (which is due to for example the change in UE state or resources) provided by the UE at 202 may be transmitted via, for example, an uplink message including the updated information. This message may include the updated constraints and/or a pointer to the constraints being updated (e.g., an earlier message with prior constraints), such that the pointer enables the network to update the UE constraints at the pointer location or flag the constraints as no longer valid due to the update.

Although the previous example describes an example where the request includes values for the UE model adaptation constraints, the UE may signal at 202 the model adaptation constraints in the form of an ML specific UE category (e.g., an ML category 1 UE). Alternatively, or additionally, the UE may inform the network of the UE's constraints with respect to ML model by using an additional entry in a first dimension of a table (as noted above at Table 1) and this entry may indicate that the UE needs the ML model within a given time (e.g., this may be the case due to an impending mobility event wherein the UE needs an ML model to perform measurement prediction of a set of cells or beams). In response, the network may take this into account as a latency (e.g., time) sensitive request for adaptation of the ML model. In another example, the UE may need to predict the latency of transmission of an ultra-reliable low latency communications (URLLC) packet in the uplink (UL) and/or downlink (DL), for which an ML model is required within a given amount of time. If the UE does not receive an updated ML model within this period of time, the UE may initiate a fallback to a non-ML model approach or may continue to use a currently active ML model.

At 203A, the network node, such as the gNB 106 or other type of network node, may prepare, based at least in part on the model adaptation constraints received at 202, the ML model, in accordance with some embodiments. For example, the gNB may prepare the ML model, which may be a “partial” ML model or a “complete” ML model. The preparation may include adapting the ML model by, for example, compressing an ML model. This compressing may take the form of changing the quantization of the ML model parameters (e.g., weights, biases, and/or other configuration and operation information for the ML model). If a UE constraint indicates the UE can only handle 16-bit quantization, the gNB may adapt the ML model by reducing the quantity of bits in the parameters to 16 bits (which may have the effect of compressing the size or footprint of the ML model when sent to the UE).

Alternatively, or additionally, the network node, such as the gNB 106 or other type of network node, may adapt the ML model by, for example, pruning the ML model. Pruning provides data compression by reducing the size of the ML model (e.g., reducing a number of nodes, layers, and/or weights). To prune, one or more nodes of the neural network may be removed for example, one or more layers of the neural network may be removed (e.g., based on the UE's ML constraint indicating a maximum number of layers a UE can handle). The pruning may also reduce the number of processing operations (e.g., in terms of FLOPs or TFLOPs) to execute the pruned ML model. With pruning and/or quantization, a larger ML model may be made smaller by removing nodes, layers, weights, connections, and/or reducing quantization to form a smaller ML model that is then transferred to the UE. In addition to reducing the processing requirements at the UE, the pruning and/or quantization may reduce the size of the ML model, such that the ML model can be more efficiently transferred over the air (or radio) interface between the UE and gNB and reduce the memory or storage footprint of the ML model. Moreover, the smaller, pruned ML model may execute more rapidly and thus provide an output (e.g., as an inference) more quickly with less latency, when compared to a larger, unpruned ML model. The pruned ML model may be, as noted, less robust (in terms of accuracy) when compared to the larger, unpruned ML model, but the amount of pruning and/or quantization may be controlled to minimize (or manage) any loss in accuracy such that the pruned ML model still provides a viable and useful alternative to the larger, unpruned ML model.

To illustrate further, some types of UE types may (based on their UE model adaptation constraints) need the network to adapt an ML model before transfer due to physical computing resource limitations. But the need to adapt the ML model may also take into account more temporal variances at the UE, such as noted state (or condition) changes at the UE due to an energy saving mode, loss of processing resources, battery level, and/or the like. In the case of pruning layers of the ML model for example, the number of layers may be defined by constraints that affect the rate at which inference may be performed (e.g., an inference latency). For example, the network (which may have more processing resources than the UE) may for a 10-layer ML model have the same or similar inference latency as a pruned 5-layer ML model executed by the UE (which may have less processing resources than the network). In some embodiments, the network may store the ML model with greater fidelity (e.g., as a larger ML model with higher quantization, higher quantity of nodes, layers, weights, and/or the like), when compared to the ML model that is adapted and transferred to the UE. For example, the network may store as a “complete” ML model (which, e.g., is trained and ready for inference) having a certain number of layers and quantization, but the compressed (e.g., pruned and the like) ML model transferred to the UE may have fewer nodes, layers, weights, and/or the like) and/or have parameters quantized down from 32 bits to 24 (or 16 bits), for example to enable the pruned ML model to fit into a smaller memory footprint at the UE.

Alternatively, or additionally, the network, such as the gNB 106 or other type of network node, may receive a plurality of sets of model adaptation constraints and form a group of UEs that require a given ML model. In this example, the UE group may have the same (or similar) set of model adaptation constraints and the UE group may have a requirement for the same (or similar) ML model for a required use case or ML task. In this example, the network may perform the adaptation of the ML model for a given ML model and provide the given ML model to the entire UE group. Alternatively, or additionally, the network may combine UE requests form a plurality of UE having the same (or similar) set of constraints and perform a single preparation of the ML model the entire group (or cluster).

During the adaptation of the ML model at 203A, the adaptation may take into account whether the requested ML model is for a time sensitive or a critical service, such as URLLC, in which case a larger amount of UE processing resources may be allocated at the UE, when compared to non-time sensitive services. Alternatively, or additionally, the UE may, at 202, indicate to the network whether the ML model is for a time sensitive or critical service, such as URLLC. Alternatively, or additionally, a given ML model may map to a task that is time sensitive or critical, so in this example the request for the ML model implicitly indicates to the network that the model is for a time sensitive task. Alternatively, or additionally, some UEs may be more tolerant of errors in the ML model, when compared to other ML models. When this is the case, a UE may, at 202, indicate to the network an indication regarding the amount of error (in the ML model) that can be tolerated (or allowed) by the UE. The network may take this into account during preparation at 203A. For example, a UE may indicate that it prefers a very low ML model error rate, in which case the network may perform less pruning when compared to a ML model provided to a UE that indicates that it tolerates ML errors. Some initial number of layers may be set by simulation or training the ML model for the types provided so as to allow setting the number of layers to match a given inference latency rate. In other cases for example, this information may be applicable to a particular class of UEs supporting high reliability e.g., URLLC type of traffic. This information may then be signaled to the UE either when requested, or grouped for UEs with similar requirements.

Alternatively, or additionally, the network, such as the gNB 106 or other type of network node, may wait to prepare an ML model at 203A until it has a plurality of requests (from a plurality of UEs) that can be clustered into a group having the same (or similar) constraints and/or same (or similar) required for a given type of ML model. Alternatively, or additionally, the network may form multiple clusters of the same (or similar) UEs (with respect to constraints and need for a given type of ML model). In this example, the network may prepare (e.g., by pruning or quantization reduction) an ML model for each cluster and response to with a single ML model for a given one of the clusters.

Alternatively, or additionally, the formation of groups of UEs may use a profile. In the case of the profile, a set of model adaptation constraints may be collected over time and stored at for example a server, such as server 109, an edge server, and/or other type of server. The profile refers to a collection of set of model adaptation constraints that are gathered over time for a group of UE(s) and/or classified according to UE categories, types, and/or task being performed by the UE. If a UE's profile matches a stored profile in the server, the profile may be quickly accessed to provide the set of constraints (and thus define the amount of adaptation to be performed for the ML model). To illustrate further, a group of UEs may be of the same type, such as IoT sensors, vehicle-to-everything (V2X) mobile devices, and/or the like. As such, if the profile of the IoT sensor matches a profile stored in a database at the server 109, the database can adapt the ML model for the constraints mapped to the IoT device profile.

At 204A, the network node 106 may initiate a transfer of an ML model (which as noted may be a partial or a complete ML model), in accordance with some embodiments. For example, in response to the network node (also referred to as an access node) being able to adapt the ML model based on the model adaptation constraints of the UE, the ML model (which is prepared at 203A) may be transferred over the air interface from the gNB 106 to the UE 102A. The ML model transfer may include a transfer of the parameters of the ML model, such parameters may include for example weights of the connections (and/or other parameters or metadata for the configuration and/or execution of the ML model).

Alternatively, or additionally, the ML model transfer 204A may also include information (also referred to as “assistance information”), which may indicate for example how to monitor the performance of the ML model and/or whether (and/or when) to report the performance to the network. For example, the assistance information provided to the UE at 204A may include at least one instruction for monitoring performance of the machine learning model and/or for monitoring at least one user equipment performance indicator. Moreover, the network may initiate a ML transfer with a ML model (e.g., version 1 of the ML model) and assistance information (e.g., version 1). This assistance information may instruct the UE to record and report back to the network the UE's consumption of hardware and/or software resources (e.g., reporting back to the network a percentage available processor resources being used relative to processor resources available at the UE, a percentage of a buffer consumed relative to available buffer capacity, and/or the impact of other UE constraints such as radio measurement performance, overheating, inference latency, and the like when executing the ML model). Table 2 below depicts an example of the parameters recorded by the UE and reported back to the network. The parameters may be used by the network to accept the ML model (e.g., V1) for use at the UE, reject the ML model (e.g., if it degrades the operation of the UE below a threshold level), and/or further adapt the ML model to form a new version of the ML model, which can be transferred as V2 to the UE. The data set identifier (ID) may provide a pointer or a reference to a collection of labelled data samples (or data sets) that are used for model training and validation purposes.

TABLE 2

| | Model | Assistance information |
|---|---|---|
| Data set ID | version | (parameters) |
| DS#1 | V1 | Percentage of available hardware resources |
| | | being used while executing the ML model; |
| | | amount of software buffer consumed by |
| | | the ML model (e.g., in a percentage |
| | | relative to what has been signaled to the |
| | | network at 202), impact to other |
| | | functionality, such as radio measurement |
| | | performance, overheating, inference |
| | | latency, etc. |
| DS#2 | V2 | Percentage of available hardware resources |
| | | being used while executing the ML model; |
| | | amount of software buffer consumed by |
| | | the ML model (e.g., in a percentage |
| | | relative to what has been signaled to the |
| | | network at 202), impact to other |
| | | functionality, such as radio measurement |
| | | performance, overheating, inference |
| | | latency, etc. |

At 205A, the UE 102A may apply the ML model provided at 204A by training the ML model or for the inference of the ML model, in accordance with some example embodiments. Moreover, the UE may also monitor the effects of the ML model at the UE and/or monitor at least one user equipment performance indicator. This monitoring may be in response to the assistance information (and in particular the instruction(s)) provided at 204A (which may indicate to the UE whether (and what) to monitor performance, what resource(s) to monitor at the UE, and/or whether (and/or when) to report back the observations obtained via the monitoring). For example, the monitoring may include observing the change in processor resources, memory resources, impact to other functionality (e.g., radio measurement performance, overheating, inference latency, etc.) and/or the like and reporting the observations to the network, such as the gNB 106 or other type of network node. In some embodiments, the assistance information may instruct the UE to report back if for example processor resources (or, e.g., memory and/or the like) used while executing the ML model at the UE exceed a threshold amount; and if the threshold exceed, the UE reports back to the network. At 206A, the UE may report to the network any observation performed by the UE (which may as noted be indicated by the assistance information provided at 204A). For example, the UE may transmit to the access node (which in this example is a gNB) information on the performance of the ML model (and/or a UE performance indicator). At this stage, the UE may continue to use the ML model (if. E.g., the UE so chooses).

Referring again to 205A, the UE 102A may record observation related to the consumption of resources at the UE during ML model execution and report at 206A the observation. These observations may (as noted above with respect to Table 2), be used by the UE (or network) to accept a ML model for use at a given UE. If for example the observations indicate the performance of the ML model decreases below a threshold performance (e.g., with respect to resources at the UE as noted above), the network may not “accept” the use of the prepared ML model at the UE (as well as other UEs with the same or similar constraints). The observed information may be formatted into a two dimensional form where the first dimension comprises of the information described earlier and the 2nd dimension would be the data set identifier used for the acceptance process for the model in the model transfer feedback message.

At 207, the network node 106 may use the received feedback at 206A to adapt (e.g., tune) how the ML model is prepared for the UE. If for example the feedback indicates the processor resources exceed a threshold amount of processor resources, the network may do additional compressing, such as pruning (or decrease quantization) of the ML model, and provide an updated ML model at 208. Likewise, if the feedback indicates the processor resources are below the threshold amount of processor resources, the network may undue some of the pruning (e.g., add nodes, layers, or increase quantization) of the ML model and provide an updated ML model (e.g., version 2 of the ML model) at 208. In some embodiments, the model transfer at 208 (e.g., ML Model version 2 (v2)) may include only the changed parameters of the ML model). Alternatively, or additionally, the model transfer at 208 (e.g., ML Model version 2) may include the entire ML model (e.g., all of the parameters of the ML model).

FIG. 2B depicts another example of a process for signaling, in accordance with some embodiments. FIG. 2B is similar in some respects to FIG. 2A, so the process at FIG. 2B includes 201, 202, 203A, and 204A noted above. But at 205B, the UE 102A cannot apply (or chooses not to apply) the ML model due to for example model adaption constraints at the UE. The constraints may include a local model adaption constraint, such as the UE choosing to fall back to a non-ML mode or other type of constraint (e.g., a change in the mode of the UE, such as power savings mode, and/or the like). When the UE cannot apply (or chooses not to apply) the ML model, the UE may respond at 206B to the network node 106 with an indication of a failure (labeled “model application failure”). The message at 206B may also include a cause of the failure and/or an activation delay. For example, the cause may indicate a reason why the UE chose not to apply the ML model, while the activation delay refers to a maximum time before which the model is required to be applied (e.g., due to the underlying use case requirement). To illustrate further, the UE may not use the ML model due to an inference latency requirement (e.g., the latency for providing the ML model's inference exceeds a threshold latency), so the ML model cannot be applied or used. To illustrate with another example, the UE may not be able to use the ML model due to a run-time execution issue, in which case the ML model cannot be executed at the UE. At 210, the UE may, in response to not being able to use the ML model, switch to a non-ML mode of operation for a task or continue to use a current ML model (e.g., an ML model being used prior to the model transfer at 204A).

FIG. 2C depicts another example of a process that provides signaling, in accordance with some embodiments. FIG. 2C is similar in some respects to FIG. 2A, so the process at FIG. 2C includes 201 and 202 but at 203C the network node 106 cannot prepare an ML model based on the UE model adaption constraints provided to the network at 202. For example, the network node 106 may receive the set of constraints 202 and note that for a given ML model, the ML model should not be executed at the UE as the model adaption constraints indicate the UE cannot handle the execution of the ML model (even with adaptation) and/or the amount of requested/needed compression (e.g., pruning, quantization, and/or the like) will yield an ML model below a threshold level of accuracy. In some implementations, the UE may be responsible for the adaptation of the ML model, so the ML model is fully transferred to the UE to allow adaptation by the UE.

When the network cannot prepare the ML model based on the UE's model adaption constraints, the network node 106 may at 204C indicate to the UE that the network node 106 cannot transfer an adapted ML model and/or may instead transfer a “full” ML model (where “full” refers to an ML model which is full that is has not been adapted at 203C by the network). The model transfer also may include assistance information as noted above but the assistance information may also indicate that the ML model is a “full” unpruned ML model.

At 205C, the UE may choose to adapt (e.g., compress by for example prune or otherwise adapt) the ML model received at 204C based on the UE's model adaption constraints. At 206C, the UE may respond to the network with feedback in the form of observations as noted above with respect to 206A or an indication failure as noted above with respect to 206B. At 207C, the UE may continue in its current state (e.g., using an ML model or non-ML model for a task) or switches to the ML model provided and adapted at 204C/205C based on the feedback.

To illustrate further the example of FIG. 2C, the network node 106 may be unable to prepare an ML model with the UE's constraints, in which case the network node does not perform pruning/quantization. When this is the case, the network node may transfer the full ML model to the UE and leaves it up to the UE to prune the model leaving it to UE implementation. In this example, the network node may still provide assistance information about the ML model that assists the UE in (if any) model pruning and/or quantization process and/or other metadata to assist the UE in training or inference. In an example use case, the network node may guide (e.g., via assistance information) the UE to use a given configuration (e.g., 16 bit quantization, pruning of 2 layers, and direct connection of inner layers). In another example, the network node may guide (e.g., via assistance information) the UE to use 24 bit quantization and remove 3 layers. In another example, the network node may guide (e.g., via assistance information) the UE to consider removing 2 layers. The UE may (given this assistance information) decide after it performs the ML model adaptation (e.g., pruning, quantization, layer removal, and/or the like), if the resulting ML model can be execute at the UE. In another example, the UE (which received, the full ML model at 204C) may use a side link communication (e.g., the Proximity Services, ProSe) upon indication from the network to exchange the full ML model with other UEs having a similar or a same constraints (or a similar or a same category) so that the UEs can also perform the ML model adaptation. In some embodiments, the UE may also exchange a pruned/quantized ML model if there is a constraint in the amount of data that can be exchanged with the neighboring (side link) UE(s).

As noted above, the UE 102A may provide to the network node 106 the UE's model adaption constraints with respect to ML model execution as category information (“ue-MLcategory”) that indicates UE's capabilities for ML model execution. Table 3 below depicts an example of the UE category information. For example, the network node may receive the UE category information and treat the category information as indicative of the set of constraints for the UE, such that the category information allows the network to prepare the ML model based on the UE's unique constraints. The UE category information may be pre-defined, such as in a standard or 3GPP standard to enable standardization in the system.

Referring to Table 3, the UE categories for machine learning may be defined based on a variety of factors. For example, categories may define that the UE may have one or more of the following constraints:
a memory size of a given size (e.g., in megabytes) for the trained ML model which is to be hosted at the UE;
an amount of supported quantization for the ML model parameters (e.g., weights, biases, and/or other configuration information for the ML model);
a maximum number of training parameters for the ML model, which may correspond to the total number of parameters to be estimated during the training of an ML model (e.g., in a neural network of 2 hidden layers and 50 hidden nodes per layer, the maximum number of training parameters may correspond to a total of 261,000 of trainable parameters);
data handling capacity (including memory) which determines what length of data batches the UE is able to handle to perform model training (e.g., data handling capacity can also refer to the limitations in the amount of training iterations the UE is able to do);
an inference speed test (e.g., how long it takes a UE to perform an inference using a given ML model), which may be a cumulative distribution function (CDF) of the inference times for a group of data samples;
training speed tests (how long does it take to train a ML model given a particular dataset); and/or
willingness (or preference) of the UE to host ML models.

TABLE 3

| UE ML | UE Memory | Quantization | Maximum number of |
|---|---|---|---|
| Category | size (MB) | (bits) | training parameters |
| Category 1 | 16 | 8 | 500K |
| Category 2 | 16 | 16 | 500K |
| Category 3 | 32 | 8 | 500K |
| Category 4 | 32 | 16 | 500K |

In some embodiments, the network may determine that a given UE may be able to use a particular ML model (e.g., for a given task or use case) only when the UE has a provided UE category information with respect to ML. To illustrate further, each of the ML models (which the network node 106 is able to transfer to a UE) may have a minimum ue-MLcategory mapped to the ML model. In this example, the network node sends a ML model to the UE when the signaled ue-MLcategory meets or exceeds the ML model's minimum (“ue-MLcategory. Moreover, the network node may cluster, as noted, the UE's based at least in part on the UE category information (ue-MLcategory) with respect to ML.

The following provides an example for purposes of illustration of how the network can prepare an ML model based on the indication of the UE category information with respect to ML (“ue-MLcategory”). For example, the gNB may include or have access to a trained “complete” ML model (which uses 1,200,000 parameters, each of the parameters are quantized as 32 bit integers and the whole ML model occupies 65 megabytes (MB). In this example, the UE may indicate at 202 for example or at other times, ue-MLcategory of 3. In this example, the network may prepare the ML model as follows. Prune an ML model to reduce the number of trainable parameters to 500,000 (e.g., using an iterative process or based on the outcome of earlier pruning procedures for similar ML models, such that the accuracy of the pruned ML model may be checked and if the accuracy meets a threshold accuracy, further adaptation of the ML model may occur). The further adaptation may quantize the ML model to match the UE's ue-MLcategory of 3, which in this example corresponds to 8 bit integer per parameter (so the 32 bit integers are truncated to 8 bits), and again the accuracy of the pruned and quantized model is checked and if the accuracy meets a threshold accuracy, further adaptation may be performed. And, the further adaptation may include memory size of the pruned and quantized ML model, such that the memory size is compared with the allowed size indicated by the ue-MLcategory 3 (which in this example is 32 megabytes, MB); if the pruned and quantized model size is smaller than the maximum allowed value of 32 MB, the adaptation may be considered complete, so the ML model is ready to be transferred to the UE at 204A, for example. After an adaptation of the ML model, if a check (e.g., accuracy and/or memory footprint) results in a negative evaluation, the adaptation may be repeated with a change (e.g., by varying the available model hyperparameters for the training procedure, until a suitable model format is achieved). In operation, the process for preparing the ML model may also vary based on the type of ML model (e.g., whether the ML model is a convolutional neural network (CNN), deep neural network (DNN), long short-term memory network (LSTM), and/or other type of ML model), so the ML-enabled function description might also need to include some information about the general ML model type used or acceptable by the UE.

In some embodiments, there may be a partial transfer of learning from the network node 106 to the UE 102A. When this is the case, there may be a requirement that a partial ML model transfer occur from gNB to UE. When this is the case, a first part in UE ML model may be considered static (which should not be changed by the UE) and the second part may be changed by the UE, so in a ML model transfer to the UE, the UE may change the second part of the ML model. In this example, the model transfer may indicate which portions may be changed (e.g., changed during training) by the UE.

In some embodiments, the network node 106 may include ML models adapted based on a set of model adaption constraints (e.g., using a profile collected over time from a large and diverse UE population). When this is the case, the ML model transfer may be rapid. The network may choose to inform UE(s) either using system information broadcast, a dedicated message, or in other way about the existence of adapted ML models that are immediately available for delivery to a UE. For example, the broadcast may indicate to a group of IoT devices performing a given task that an adapted ML model is available for use.

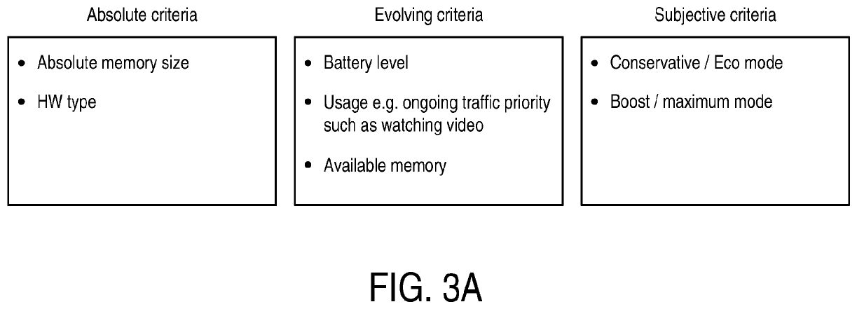

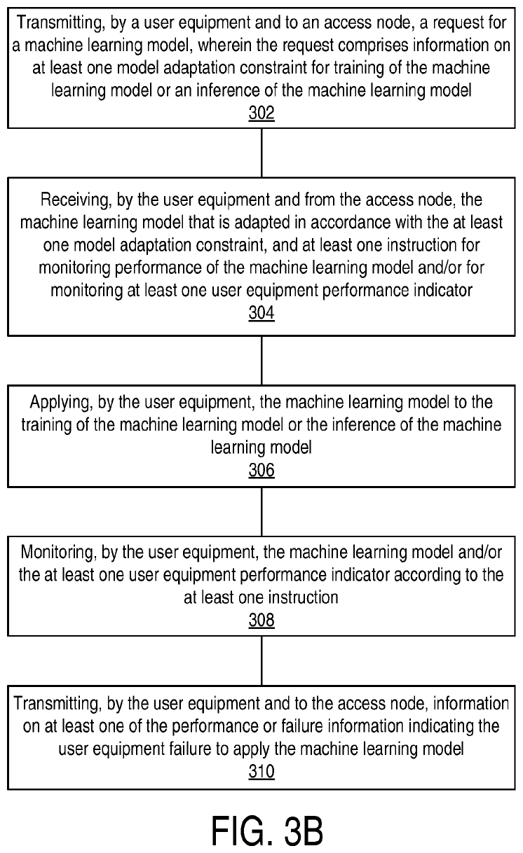

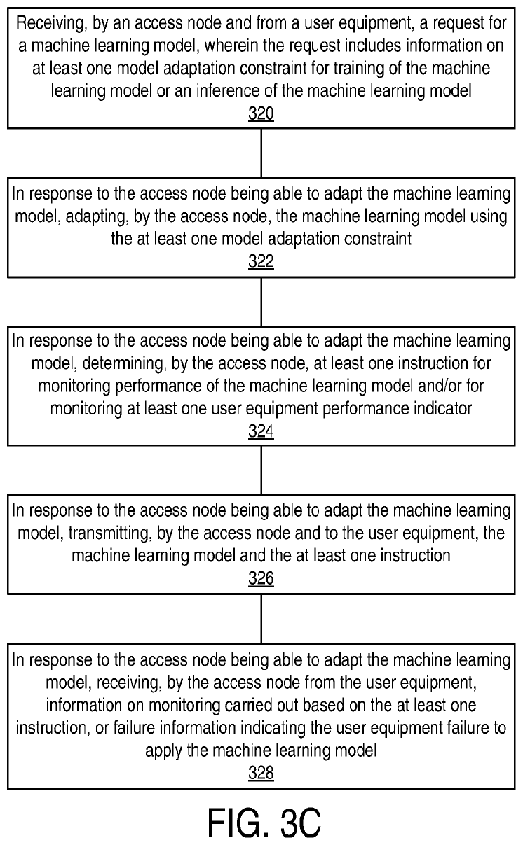

In some of the examples, the set of model adaption constraints may be abstractly shared without exposing the UE's underlying architecture to the network (e.g., abstract enough to cover a few levels in a real-time model transfer). One such example implementation of a set of constraints is a UE profile as noted above. Moreover, some of the UE model adaption constraints may be more static, such as absolute constraints, while other constraints may be more dynamic, such as evolving constraints, and other constraints may be also be subjective. Referring to FIG. 3A, the model adaption constraints may include an absolute set of criteria, such as an absolute memory size, hardware type, and/or the like. Alternatively, or additionally, the criteria may also include a list of evolving criteria such as semi-static criteria, example of which include an ongoing traffic level at the UE, ongoing battery level, available memory, processing power, and/or the like). Alternatively, or additionally, the criteria may also a set of subjective criteria that may be guided by the end user, example of such criteria may include eco-mode (or battery save) configured at the UE, a maximum performance mode, and/or the like. Alternatively, or additionally, the set of constraints or the ue-MLcategory may also be used. In defining a set of abstract criteria, UE vendors may be allowed to indicate the UE ML capability, without having to expose the workings of the architecture of the UE (which may be considered proprietary or private). In other words, some of the constraints may vary over time (and thus more dynamic), such as the battery level of the UE, mode the user puts the UE in such as a power saving mode.

With UEs being resource-constrained or cost-limited with respect to computing resources, there may be one or more challenges with using machine learning on edge devices, such as the UE (e.g., IoT devices, mobile devices, and/or the like). The design choice for the machine learning model algorithm establishes constraints on the extent the ML model can be adapted after deployment. For example, a machine learning model architecture with low number of layers and unique input (and/or output layers) may leave little room for ML model architectural adaptation, such as changing a quantity of the layers, changing a size of the input (and/or output) layers, and/or other adaptations. In this context, machine learning model adaptation may further include adaptation of the input data pre-processing and/or output data post-processing. Even when the ML model is deployable and supports certain adaptation options, the battery-life of the edge device, such as the UE, may cause limitations for computing capacity. Moreover, some applications, services, and/or use case may have strict latency requirements (e.g., time requirements with respect to how long it takes the ML model to perform an inference or how long it takes the ML model to converge when training). To obtain fast and accurate inferences on UEs, the ML model may be optimized for real-time inference (or updates for ML model training), which may be carried out by ML model compression techniques, such as pruning, quantization, and/or the like.

Adaptation by weight quantization is another option for ML model compression as it reduces the numerical precision of weights to a lower bit value. Pruning (or sparsification) may be used as an ML model compression technique in machine learning to reduce the size of the ML Model by removing elements of the ML model that are non-critical and/or redundant from a ML standpoint. In the case of pruning (or sparsification), the ML model may be optimized for real-time inferences for resource-constrained devices, such as UEs. The ML model pruning may also be used with other ML model compression techniques such as quantization, low-rank matrix factorization, and/or the like, to further reduce the size of the ML model. The original, unpruned ML model and the pruned ML model may have the same (or similar) architecture in some respects but the pruned model being sparser (e.g., with weights with the low magnitude being set to zeros).

With respect to ML model monitoring, this may be performed during for example an operational stage of the machine learning lifecycle: changes in a machine learning model performance are monitored, such as model output performance, input data drift, and/or concept drift for ensuring that the model is maintaining an acceptable level of performance. For example, the monitoring may be carried out by evaluating the performance on real-world data. The monitored performance indicator may be system performance indicators or intermediary performance indicators. With respect to ML model compression, the same training data may be used for both the original ML model and the compressed (e.g., adapted) ML model. ML model monitoring may be based on evaluation metrics and related conditions, such as threshold values. The choice of the evaluation metrics (e.g., confusion matrix, accuracy, precision, recall, and F1 score) may depend on a given machine learning task, and the ML model being used.

FIG. 3B depicts an example process at a user equipment for ML model adaption, in accordance with some embodiments.

At 302, the user equipment may transmit, by a user equipment and to an access node, a request for a machine learning model, wherein the request includes information on at least one model adaptation constraint for training of the machine learning model or an inference of the machine learning model, in accordance with some embodiments. For example, the UE 102 may transmit towards an access node (e.g., a radio access node, gNB base station, server, such as an edge server) a request for a ML model as noted in the examples of FIGS. 2A-C at 202. The request may include at least one model adaptation constraint for the ML model while training or inferring. The model adaptation constraint may one or more constraints. Alternatively, or additionally, the model adaptation constraint may be in the form of a UE category (such as the categories noted above with respect to Table 3) that map to one or more constraints with respect to the UE's training of a machine learning model and/or the UE performing inferences using the machine learning model. The model adaptation constraints may include a constraint related to the machine learning model (e.g., a worst case inference latency requirement for the ML model, an average inference latency, a maximum number of predicted time steps in case of predicting a future series of events, a time window duration corresponding to the number of predicted time steps, and/or the like), a constraint related to a user equipment resource constraint (e.g., available processor resources, memory resources, and the like), a battery life of the user equipment, as well as other types of constraints that impact the model adaptation.

At 304, the user equipment may receive from the access node the machine learning model (that is adapted in accordance with the at least one model adaptation constraint) and may receive at least one instruction for monitoring performance of the machine learning model and/or for monitoring at least one user equipment performance indicator, in accordance with some embodiments. For example, the UE 102A for example may receive (e.g., as shown at 204A) from the access node a ML model which has been adapted using the at least one model adaptation constraint. Given a model adaptation constraint of a power save (or low battery) mode at the UE for example, the ML model may be adapted to reduce its size, which may reduce the time (or latency) for the ML model to perform an inference. With respect to the at least one user equipment performance indicator, the performance indicator may include key performance indicators (KPIs) for different network segments, layers, mechanisms, aspects, services, and/or activities. The UE performance indicator may indicate performance in relation to network transport, front-haul, a radio link quality, a data plane efficiency, and/or control plane operations (e.g., hand over execution time, user attachment time, and/or the like). Additional examples of UE performance indicators (e.g., KPIs) include latency, throughput for a network and/or a network slice, UE throughput, UE power consumption, and/or the like. The network (e.g., a node of the network) may instruct the user device to monitor performance of the ML model and/or monitor UE performance in terms of the UE monitoring performance of the machine learning model and/or for monitoring at least one user equipment performance indicators.

At 306, the user equipment may apply the machine learning model to the training of the machine learning model or the inference of the machine learning model, in accordance with some embodiments. Referring to the example of FIG. 2A at 205A for example, the UE may apply the ML model at the UE by using the ML model for inference or to train the ML model.

At 308, the user equipment may monitor the machine learning model and/or the at least one user equipment performance indicator according to the at least one instruction, in accordance with some embodiments. Referring to FIGS. 2A-2B for example, the UE may receive one or more instruction at 204A. The instructions may inform the UE regarding observing the performance of the ML model and/or the UE performance (e.g., the user equipment performance indicator(s)) while using the ML model for training or inference. By way of another example, the instruction may include one or more metrics for evaluating the performance of the machine learning model and/or the UE (e.g., latency of an inference, impact to the UE's ability to perform other tasks, such as radio and/or channel quality measurements (e.g., for measuring frequencies the UE is currently operating on as well as the frequencies within the same radio access technology or outside current radio access technology and/or the like)). Alternatively, or additionally, the instruction may include a KPI or other condition, such as a performance degradation of the user equipment when using the ML model for training or inference. For example, the condition may include a threshold value (e.g., a percentage usage of a processor, memory, and/or other resource), and if the threshold value is exceeded, the UE reports the observation to the access node.

At 310, the user equipment may transmit to the access node information on at least one of the performance or failure information indicating the user equipment failure to apply the machine learning model, in accordance with some embodiments. For example, the UE 102A may transmit as feedback to the access node one or more observations made based on the instruction to monitor performance. Alternatively, or additionally, the UE 102A may transmit to the access node an indication of a failure to apply the ML model at the UE (see, e.g., 206B). For example, if the UE cannot use the ML model (e.g., due to a local constraint at the UE or a change to a constraint), the UE may choose to not use the ML model for training or inference. When this is the case, the UE may indicate to the access node a failure.

In some embodiments, the ML model received at 304 is not adapted by the access node, in accordance with some embodiments. Referring to the example of FIG. 2C at 203C-204C, the access node (which in this example is gNB 106) may not be able to adapt the ML model given the UE's model adaptation constraint(s). When this the case, the UE may receive (from the access node) a machine learning model that has not been adapted (e.g., un-adapted ML model) to allow the UE to adapt the ML model. The un-adapted ML model may be received with instructions for monitoring performance of the machine learning model and/or for monitoring the UE performance indicator so the UE can report back to the access node. The access node may provide assistance information to the UE, such as information indicating the ML model is not adapted. In the case of the UE receiving the un-adapted ML model, the UE may adapt the ML model and then continue with the applying (306), the monitoring (308), and/or the transmitting (310).

In some embodiments, in response to the performance indicating there is no failure to apply the machine learning model at the user equipment, the UE may continue to use the machine learning model as noted in the example of 210. Alternatively, or additionally, in response to the performance indicating there is a failure to apply the machine learning model at the user equipment, the UE may switch as a fallback to a non-machine learning mode for performing a task of the machine learning model and/or switch to a prior version of the machine learning mode for performing the task.

In some embodiments, the machine learning model may be adapted in accordance with the at least one model adaptation constraint by at least compressing the machine learning model. This compressing may reduce the size of the ML model. The compressing may take the form of pruning weights from the ML model (e.g., weight pruning), a structural pruning (e.g., removing layers, nodes, and the like), quantization changes (e.g., weight quantization from 32 to 16 bits), and/or machine learning model architecture change (e.g., choosing another type of ML model, such as a convolutional neural network (CNN) instead of a multi-layer perceptron (ML)).

FIG. 3C depicts an example process at an access node for ML model adaption, in accordance with some embodiments.

At 320, the access node may receive from a user equipment a request for a machine learning model, wherein the request includes information on at least one model adaptation constraint for training of the machine learning model or an inference of the machine learning model, in accordance with some embodiments. Referring to FIGS. 2A-2C at 202 for example, the access node (which in this example is a gNB) may receive from UE 102A a request for an ML model. The request may include information on at least one model adaptation constraint for ML model training of the machine learning model or ML model inference. The model adaptation constraint may include one or more values for constraints and/or a UE category (such as the categories noted above with respect to Table 3) that maps to one or more constraints with respect to the UE's training of a machine learning model and/or the UE performing inferences using the machine learning model. The model adaption constraints may include a constraint related to the machine learning model (e.g., a worst case inference latency requirement for the ML model, an average inference latency, a maximum number of predicted time steps in case of predicting a future series of events, a time window duration corresponding to the number of predicted time steps, and/or the like), a constraint related to a user equipment resource constraint (e.g., available processor resources, memory resources, and the like), a battery life of the user equipment, as well as other types of constraints. The access node may comprise or be comprised in a radio access node, a gNB base station, a server, and/or an edge server (e.g., a server coupled to a gNB or located with the gNB).

At 322, in response to the access node being able to adapt the machine learning model, the access node may adapt the machine learning model using the at least one model adaptation constraint, in accordance with some embodiments. Referring to the example of 203A, the gNB may adapt the ML model while taking into account the UE's model adaptation constraint. The ML model adaption may include compressing, based on the model adaptation constraint(s), the machine learning model. For example, the ML model may compress by pruning weights from the ML model (e.g., weight pruning), a structural pruning (e.g., removing layers, such as hidden layers, or removing nodes), quantization changes (e.g., weight quantization from 32 to 16 bits), and/or machine learning model architecture change.

At 324, in response to the access node being able to adapt the machine learning model, the access node may determine at least one instruction for monitoring performance of the machine learning model and/or for monitoring at least one user equipment performance indicator, in accordance with some embodiments. For example, the instruction may instruct the UE regarding monitoring the ML model and/or the UE performance during the training or inference. The instruction may include one or more metrics for evaluating the performance of the machine learning model (and/or for monitoring UE performance indicator(s), such as the KPIs). Alternatively, or additionally, the instruction may include a KPI or other condition, such as a performance degradation of the user equipment when using the ML model for training or inference. For example, the condition may include a threshold value (e.g., a percentage usage of a processor, memory, and/or other resource), and if the threshold value is exceeded, the UE reports the observation to the access node.

At 326, in response to the access node being able to adapt the machine learning model, the access node may transmit to the user equipment, the machine learning model and the at least one instruction, in accordance with some embodiments. Referring to FIGS. 2A-2B at 204A for example, the gNB may transmit to the UE the ML model and instructions (e.g., assistance information and/or other types of information).

At 328, in response to the access node being able to adapt the machine learning model, the access node may receive from the user equipment information on monitoring carried out based on the at least one instruction, or failure information indicating the user equipment failure to apply the machine learning model, in accordance with some embodiments. Referring to 206A, 206B, and 206C for example, the gNB may receive from the UE feedback, which may include observations on the monitored performance of the ML model and/or UE and/or an indication of a failure to apply the ML model by the UE.

In some embodiments, the access network may not be able to adapt the ML model using the at least one model adaptation constraint provided at 320. When this is the case, the access node may (as noted in the example of 204C) provide an ML model to the UE to allow the UE to attempt to adapt the ML model.

In some embodiments, in response to receiving the information on monitoring carried out based on the at least one instruction, or the failure information indicating the user equipment failure to apply the machine learning model, the access node may further adapt the machine learning model using the information from the user equipment. Referring to FIG. 2A at 207 for example, the access node (which in this example is gNB 106) may, based on the feedback from the monitoring and/or the failure to apply the ML model, adapt the ML model. The adapted ML model may be transmitted again to the UE (either when requested or without a request as an update for example). The ML model adaption may include compressing, based on the model adaptation constraint(s), the machine learning model by, for example, pruning weights from the ML model (e.g., weight pruning), a structural pruning (e.g., removing layers, such as hidden layers, or removing nodes), quantization changes (e.g., weight quantization from 32 to 16 bits), and/or machine learning model architecture change.

In some embodiments, the at least one instruction for monitoring performance of the machine learning model may include one or more metrics for evaluating the performance of the machine learning model. Alternatively, or additionally, the at least one user equipment performance indicator may include one or more key performance indicators. For example, the instruction(s) may include one or more metrics for evaluating the performance of the machine learning model (and/or for monitoring UE performance indicator(s), such as the KPIs). Alternatively, or additionally, the instruction may include a KPI or other condition, such as a performance degradation of the user equipment when using the ML model for training or inference.

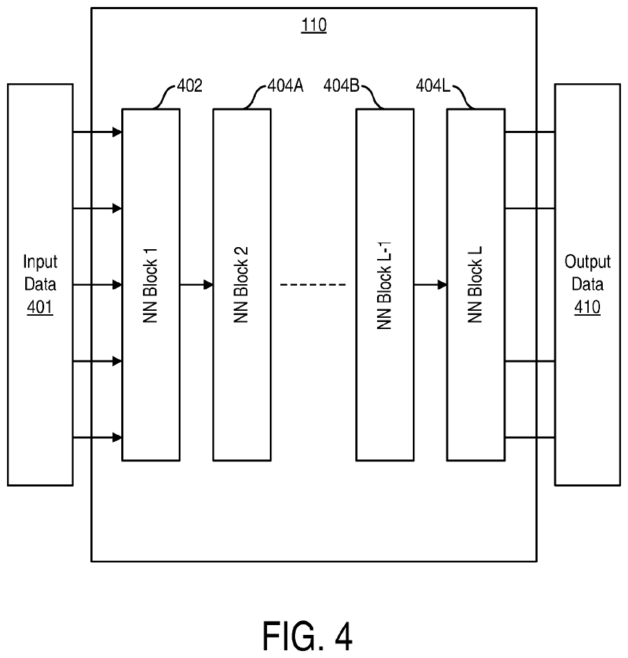

FIG. 4 shows an example of a ML model 110, in accordance with some example embodiments. In the example of FIG. 4, the ML model may include one or more blocks. For example, the first neural network (NN) Block 1 402 may receive data 410 as inputs from the UE 102A. This data may represent data such as measurements related to CSI compression, beam measurements, and/or the like. The ML model may include so-called “internal” NN blocks 404A, B, and L. For example, each internal NN block (2, . . . , L−1) may have nₕ neurons (e.g., the number of neurons), such that the NN Block L 404L generated the output 410 using, for example, M output neurons corresponding to the outputs 410 (e.g., in an inference phase the outputs correspond to the task being performed such as beam selection, CSI compression values, and/or the like while in training the outputs may correspond to “labeled” data used to train the ML model). And for example, the NN Block may be configured as a fully connected layers (FNN), activation function layers, and batch normalization layers.

At the lth NN block 404L of the example of FIG. 4, the output data 108 may be represented as a vector y^{l} is calculated with a non-linear activation function σ and can be expressed as

$${y}^{l} = σ ( {W}_{l}^{c} {y}^{l - 1} + {w}_{l}^{b} ) ,$$

where y^{l-1} is the output at the previous NN block,

$${W}_{l}^{c}$$

are the weights of the lth NN block and

$${w}_{l}^{b}$$

are the biases of the lth NN block. The weights,

$${W}_{l}^{c}$$

and biases

$${w}_{l}^{b}$$

forms the trainable parameters Wₗ of the lth NN block. The last output y^{L} corresponds to the output of the last NN block of the ML model and can be expressed using non-linear functions

$${g}_{{W}_{L}}^{( L )} , … , {g}_{{W}_{l}}^{( l )} ,$$

for i=1, . . . , L as a combination of the ML model input and trainable parameters of different NN blocks:

$${y}^{L} = {g}_{{W}_{L}}^{( L )} ( {g}_{{W}_{L - 1}}^{( L - 1 )} ( … {g}_{{W}_{1}}^{( 1 )} ( x ) ) ) .$$

The outputs 410 of the ML model 110 (NN) may be represented by y^{L}, which can be passed to a decision function (e.g., a SoftMax function), such as P_{y}=softmax(y^{L}), to obtain the probability distribution P_{y} over the set of ML model outputs. These probabilities may be ranked in, for example descending order (although they may be ranked in other ways such as ascending) and then the best K beams may be selected from the ranking as follows:

f=arg sort P_{y}

[symbol]

={fₖ|k=1, . . . , K}

where the set [symbol] includes the best K CRI resources as shown at 112, for example.

For example, the ML model 110 may be trained with a stochastic gradient descent (SGD) algorithm that computes a minimum of the loss function in a direction of the gradient with respect to the ML model weights Wₗ, although other training techniques may be used as well. In the case of SDG, given nᵢ data samples from the training set formed by input data {X⁽¹⁾, X⁽²⁾, . . . , X⁽ⁿ^{ᵢ}⁾} and corresponding labels y⁽ⁱ⁾ The SGD firstly computes gradient estimate

$$\hat{g} ← + \frac{1}{m} {∇}_{W} {\sum }_{i} Loss ( f ( {X}^{( i )} ; {W}_{i}^{t - 1} ) , {y}^{( i )} ) ,$$

then updates the weights

$${W}_{i}^{t} ← {W}_{i}^{t - 1} - η \hat{g}$$

(where η is the learning rate). SGD iterates these two steps until a stopping criterion is met. Alternatively, or additionally, the ML model may be trained in other ways as noted above using for example federated learning, unsupervised learning, and/or the like.

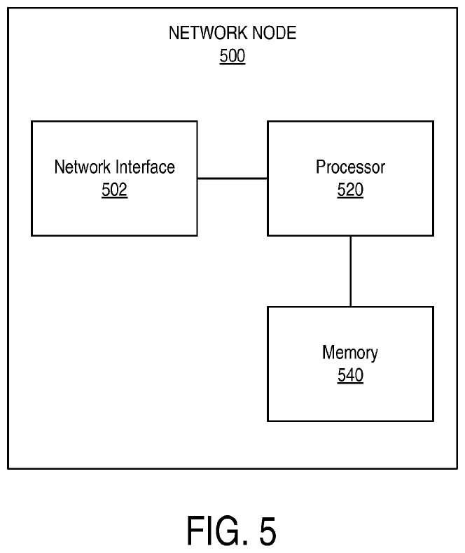

FIG. 5 depicts a block diagram of a network node 500, in accordance with some example embodiments. The network node 500 may comprise or be comprised in one or more network side nodes or functions, such as the network node 106 (e.g., gNB, eNB, DU, TRPs, coupled server 109, centralized server, edge server, and/or the like).

The network node 500 may include a network interface 502, a processor 520, and a memory 504, in accordance with some example embodiments. The network interface 502 may include wired and/or wireless transceivers to enable access other nodes including base stations, other network nodes, the Internet, other networks, and/or other nodes. The memory 504 may comprise volatile and/or non-volatile memory including program code, which when executed by at least one processor 520 provides, among other things, the processes disclosed herein with respect to the gNB (or access node), for example.

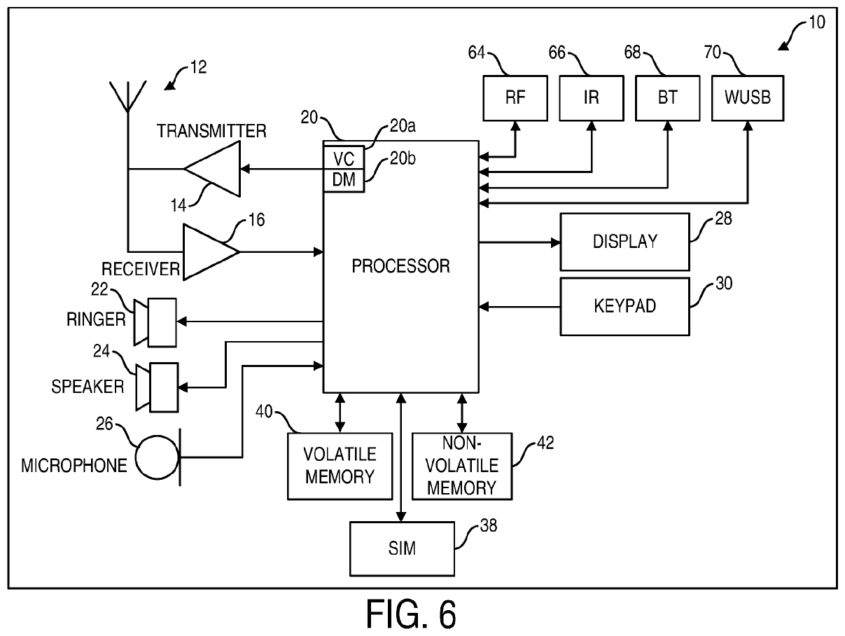

FIG. 6 illustrates a block diagram of an apparatus 10, in accordance with some example embodiments. The apparatus 10 may comprise or be comprised in a user equipment, such as user equipment 102A-N. In general, the various embodiments of the user equipment 204 can include cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions, in addition for vehicles such as autos and/or truck and aerial vehicles such as manned or unmanned aerial vehicle and as well as portable units or terminals that incorporate combinations of such functions. The user equipment may comprise or be comprised in an IoT device, an Industrial IoT (IIOT) device, and/or the like. In the case of an IoT device or ITOT device, the UE may be configured to operate with less resources (in terms of for example power, processing speed, memory, and the like) when compared to a smartphone, for example.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signalling via electrical leads to the transmitter and receiver. Likewise, processor 20 may be configured to control other elements of apparatus 10 by effecting control signalling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 6 as a single processor, in some example embodiments the processor 20 may comprise a plurality of processors or processing cores.

The apparatus 10 may be capable of operating with one or more air interface standards, communication protocols, modulation types, access types, and/or the like. Signals sent and received by the processor 20 may include signalling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, sixth-generation (6G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 6, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, U-SIM, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein.

The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiments, the application logic, software or an instruction set is maintained on any one of various conventional computer-readable media. In the context of this document, a “computer-readable storage medium” may be any non-transitory media that can contain, store, communicate, propagate or transport the instructions for use by or in connection with an instruction execution system, apparatus, or device, such as a computer or data processor circuitry; computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein may include enhanced use of ML models at a UE as the ML model can be adapted to the specific constraints at a given UE.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

1-30. (canceled)

31. A method comprising:
transmitting, by a user equipment and to an access node, a request for a machine learning model, wherein the request comprises information on at least one model adaptation constraint for training of the machine learning model or an inference of the machine learning model;
receiving, by the user equipment and from the access node, the machine learning model that is adapted in accordance with the at least one model adaptation constraint, and at least one instruction for monitoring performance of the machine learning model and/or for monitoring at least one user equipment performance indicator;
applying, by the user equipment, the machine learning model to the training of the machine learning model or the inference of the machine learning model;
monitoring, by the user equipment, the machine learning model and/or the at least one user equipment performance indicator according to the at least one instruction; and
transmitting, by the user equipment and to the access node, information on at least one of the performance or failure information indicating the user equipment failure to apply the machine learning model.

32. The method of claim 31, further comprising:
receiving, by the user equipment and from the access node, the machine learning model that is not adapted in accordance with the at least one model adaptation constraint, and the at least one instruction for monitoring performance of the machine learning model and/or for monitoring the at least one user equipment performance indicator.

33. The method of claim 31 further comprising:
receiving, by the user equipment and from the access node, the machine learning model that is not adapted in accordance with the at least one model adaptation constraint, and the at least one instruction for monitoring performance of the machine learning model and/or for monitoring the at least one user equipment performance indicator
adapting, by the user equipment, the machine learning model before continuing with the applying, the monitoring, and the transmitting information on at least one of the performance or the failure information indicating the user equipment failure to at least one of apply or adapt the machine learning model.

34. The method of claim 31, wherein in response to the performance indicating there is no failure to apply or adapt the machine learning model at the user equipment, continuing, by the user equipment, to use the machine learning model.

35. The method of claim 31, wherein in response to the performance indicating a failure to apply or adapt the machine learning model at the user equipment, switching, by the user equipment, to at least one of a non-machine learning mode for performing a task of the machine learning model and a prior version of the machine learning mode for performing the task.

36. The method of claim 31, wherein the machine learning model is adapted in accordance with the at least one model adaptation constraint by at least compressing the machine learning model by at least one of a weight pruning, a structural pruning, a weight quantization, or a machine learning model architecture change.

37. The method of claim 31, wherein the at least one model adaptation constraint includes at least one of a constraint related to the machine learning model, a constraint related to a user equipment resource constraint, a battery life of the user equipment, or a latency requirement for the inference of the machine learning model.

38. The method of claim 31, wherein the at least one instruction for monitoring performance of the machine learning model comprises one or more metrics for evaluating the performance of the machine learning model, and/or wherein the at least one user equipment performance indicator comprises one or more key performance indicators.

39. An apparatus comprising:
at least one processor; and
at least one memory including computer program code, the at least one memory and the computer program code configured to, with the at least one processor, cause the apparatus to at least:
transmit, to an access node, a request for a machine learning model, wherein the request comprises information on at least one model adaptation constraint for training of the machine learning model or an inference of the machine learning model;
receive, from the access node, the machine learning model that is adapted in accordance with the at least one model adaptation constraint, and at least one instruction for monitoring performance of the machine learning model and/or for monitoring at least one user equipment performance indicator;
apply the machine learning model to the training of the machine learning model or the inference of the machine learning model;
monitor the machine learning model and/or the at least one user equipment performance indicator according to the at least one instruction; and
transmit, to the access node, information on at least one of the performance or failure information indicating the apparatus failure to apply the machine learning model.

40. The apparatus of claim 39, wherein the apparatus is further caused to at least: receive, from the access node, the machine learning model that is not adapted in accordance with the at least one model adaptation constraint, and the at least one instruction for monitoring performance of the machine learning model and/or for monitoring the at least one user equipment performance indicator.

41. The apparatus of claim 39, wherein the apparatus is further caused to at least: receive, from the access node, the machine learning model that is not adapted in accordance with the at least one model adaptation constraint, and the at least one instruction for monitoring performance of the machine learning model and/or for monitoring the at least one user equipment performance indicator adapt the machine learning model before continuing with the applying, the monitoring, and the transmitting information on at least one of the performance or the failure information indicating the apparatus failure to at least one of apply or adapt the machine learning model.

42. The apparatus of claim 39, wherein in response to the monitoring of the performance indicating there is no failure to apply or adapt the machine learning model at the apparatus, continue to use the machine learning model.

43. The apparatus of claim 39, wherein in response to the monitoring of the performance indicating a failure to apply or adapt the machine learning model at the apparatus, switch to at least one of a non-machine learning mode for performing a task of the machine learning model and a prior version of the machine learning mode for performing the task.

44. The apparatus of claim 39, wherein the machine learning model is adapted in accordance with the at least one model adaptation constraint by at least compressing the machine learning model by at least one of a weight pruning, a structural pruning, a weight quantization, or a machine learning model architecture change.

45. The apparatus of claim 39, wherein the at least one model adaptation constraint includes at least one of a constraint related to the machine learning model, a constraint related to a resource constraint at the apparatus, a battery life of the apparatus, or a latency requirement for the inference of the machine learning model.

46. The apparatus of claim 39, wherein the at least one instruction for monitoring performance of the machine learning model comprises one or more metrics for evaluating the performance of the machine learning model, and/or wherein the at least one user equipment performance indicator comprises one or more key performance indicators.

47. An apparatus comprising:
at least one processor; and
at least one memory including computer program code, the at least one memory and the computer program code configured to, with the at least one processor, cause the apparatus to at least:
receive, from a user equipment, a request for a machine learning model, wherein the request comprises information on at least one model adaptation constraint for training of the machine learning model or an inference of the machine learning model; and
in response to the apparatus being able to adapt the machine learning model, adapt the machine learning model using the at least one model adaptation constraint,
determine at least one instruction for monitoring performance of the machine learning model and/or for monitoring at least one user equipment performance indicator,
transmit, to the user equipment, the machine learning model and the at least one instruction, and
receive, from the user equipment, information on monitoring carried out based on the at least one instruction, or of the performance and failure information indicating the user equipment failure to apply the machine learning model.

48. The apparatus of claim 47, wherein the apparatus is further caused to at least transmit the machine learning model in an un-adapted form to the user equipment, in response to the access node not being able to adapt the machine learning model using the at least one model adaptation constraint.

49. The apparatus of claim 47, wherein the apparatus is further caused to at least transmit the machine learning model in an un-adapted form to the user equipment, in response to the access node not being able to adapt the machine learning model using the at least one model adaptation constraint, and wherein in response to receiving the information on monitoring carried out based on the at least one instruction, or the failure information indicating the user equipment failure to apply the machine learning model, the apparatus is further caused to adapt the machine learning model using the information from the user equipment.

50. The apparatus of claim 47, wherein the machine learning model that is adapted in accordance with the at least one model adaptation constraint is adapted by at least compressing the machine learning model using at least one of a weight pruning, a structural pruning, a weight quantization, or a machine learning model architecture change.

51. The apparatus of claim 47, wherein the at least one instruction for monitoring performance of the machine learning model comprises one or more metrics for evaluating the performance of the machine learning model, and/or wherein the at least one user equipment performance indicator comprises one or more key performance indicators.
